(19) United States
(12) Patent Application Publication
(10) Pub. No.: US 2024/0169142 A1
(43) Pub. Date: May 23, 2024

(54) MEETING INFORMATION MANAGEMENT SYSTEM, MEETING INFORMATION MANAGEMENT METHOD, RECORDING MEDIUM STORING MEETING INFORMATION MANAGEMENT PROGRAM

(71) Applicant: SHARP KABUSHIKI KAISHA, Sakai City (JP)

(72) Inventors: HIROKO KAWAKAMI, Osaka (JP); YUICHIRO KOIZUMI, Osaka (JP)

(21) Appl. No.: 18/378,250

(22) Filed: Oct. 10, 2023

(30) Foreign Application Priority Data
Nov. 17, 2022 (JP) 2022-184025

(51) Int. Cl. G06F 40/117; G06F 40/194

(52) U.S. Cl. CPC G06F 40/117; G06F 40/194

(57) ABSTRACT

A meeting information management system includes: one or more processors; and a display device, where the one or more processors acquire minutes information of a meeting; determine a feature element representing a feature of the minutes information, based on the minutes information, and set the determined feature element to the minutes information; and in a case where a plurality of pieces of the minutes information to which the feature element is set are associated with each other, cause the plurality of pieces of minutes information, and the feature element associated with each of the plurality of pieces of minutes information to be displayed in an identifiable manner on the display device.

### INCORPORATION BY REFERENCE

This application is based upon and claims the benefit of priority from the corresponding Japanese Patent Application No. 2022-184025 filed on Nov. 17, 2022, the entire contents of which are incorporated herein by reference.

### BACKGROUND

The present disclosure relates to a meeting information management system, a meeting information management method, and a recording medium storing a meeting information management program.

Conventionally, a system has been known in which important points of a meeting can be easily recognized when minutes are reviewed afterward by extracting the important points from the minutes of the meeting, and registering the important points in association with the minutes.

However, in the conventional art, although it is possible to recognize important points for each meeting, for example, in a case where a meeting of the same agenda is held a plurality of times, it is difficult to recognize relevance of each meeting, progress of a topic, and the like. Generally, there are many cases where a meeting is held a plurality of times, and it is desirable to be able to recognize relevance of the entirety of a plurality of meetings.

### SUMMARY

An object of the present disclosure is to provide a meeting information management system, a meeting information management method, and a recording medium recording a meeting information management program that enable to easily recognize relevance of a plurality of meetings.

A meeting information management system according to an aspect of the present disclosure includes: one or more processors; and a display device, where the one or more processors acquire minutes information of a meeting; determine a feature element representing a feature of the minutes information, based on the minutes information, and set the determined feature element to the minutes information; and in a case where a plurality of pieces of the minutes information to which the feature element is set are associated with each other, cause the plurality of pieces of minutes information, and the feature element associated with each of the plurality of pieces of minutes information to be displayed in an identifiable manner on the display device.

A meeting information management method according to another aspect of the present disclosure is a meeting information management method executed by one or more processors, the method including; acquiring minutes information of a meeting; determining a feature element representing a feature of the minutes information, based on the minutes information, and setting the determined feature element to the minutes information; and in a case where a plurality of pieces of the minutes information to which the feature element is set are associated with each other, causing the plurality of pieces of minutes information, and the feature element associated with each of the plurality of pieces of minutes information to be displayed in an identifiable manner.

A recording medium according to another aspect of the present disclosure is a recording medium storing a meeting information management program for causing one or more processors to execute: acquiring minutes information of a meeting; determining a feature element representing a feature of the minutes information, based on the minutes information, and setting the determined feature element to the minutes information; and, in a case where a plurality of pieces of the minutes information to which the feature element is set are associated with each other, causing the plurality of pieces of minutes information, and the feature element associated with each of the plurality of pieces of minutes information to be displayed in an identifiable manner.

According to the present disclosure, it is possible to provide a meeting information management system, a meeting information management method, and a recording medium storing a meeting information management program that enable to easily recognize relevance of a plurality of meetings.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a functional block diagram illustrating a configuration of a meeting information management system according to an embodiment of the present disclosure.

FIG. 2 is a diagram illustrating an example of minutes to be created in a user terminal according to the embodiment of the present disclosure.

FIG. 3 is a diagram illustrating an example of meeting information utilized in the meeting information management system according to the embodiment of the present disclosure.

FIG. 4 is a diagram illustrating an example of a tag setting screen to be displayed on the user terminal according to the embodiment of the present disclosure.

FIG. 5 is a diagram illustrating an example of a minutes list screen to be displayed on the user terminal according to the embodiment of the present disclosure.

FIG. 6 is a diagram illustrating an example of a tag setting screen to be displayed on the user terminal according to the embodiment of the present disclosure.

FIG. 7 is a diagram illustrating an example of a minutes list screen to be displayed on the user terminal according to the embodiment of the present disclosure.

FIG. 8 is a diagram illustrating an example of a tag setting screen to be displayed on the user terminal according to the embodiment of the present disclosure.

FIG. 9 is a diagram illustrating an example of a minutes list screen to be displayed on the user terminal according to the embodiment of the present disclosure.

FIG. 10 is a diagram illustrating an example of a minutes list screen to be displayed on the user terminal according to the embodiment of the present disclosure.

FIG. 11 is a diagram illustrating an example of a minutes list screen to be displayed on the user terminal according to the embodiment of the present disclosure.

FIG. 12 is a diagram illustrating an example of a minutes list screen to be displayed on the user terminal according to the embodiment of the present disclosure.

FIG. 13 is a diagram illustrating an example of a minutes list screen to be displayed on the user terminal according to the embodiment of the present disclosure.

FIG. 14 is a flowchart for explaining an example of a procedure of meeting information management processing to be performed by the meeting information management system according to the embodiment of the present disclosure.

FIG. 15 is a diagram illustrating an example of a minutes list screen to be displayed on the user terminal according to the embodiment of the present disclosure.

FIG. 16 is a diagram illustrating an example of a minutes list screen to be displayed on the user terminal according to the embodiment of the present disclosure.

FIG. 17 is a diagram illustrating an example of a tag setting screen to be displayed on the user terminal according to the embodiment of the present disclosure.

FIG. 18 is a diagram illustrating an example of a minutes list screen to be displayed on the user terminal according to the embodiment of the present disclosure.

FIG. 19 is a diagram illustrating an example of a chart screen to be displayed on the user terminal according to the embodiment of the present disclosure.

### DETAILED DESCRIPTION

Hereinafter, an embodiment according to the present disclosure is described with reference to the accompanying drawings. Note that, the following embodiment is an example embodying the present disclosure, and does not limit the technical scope of the present disclosure.

Meeting Information Management System 10

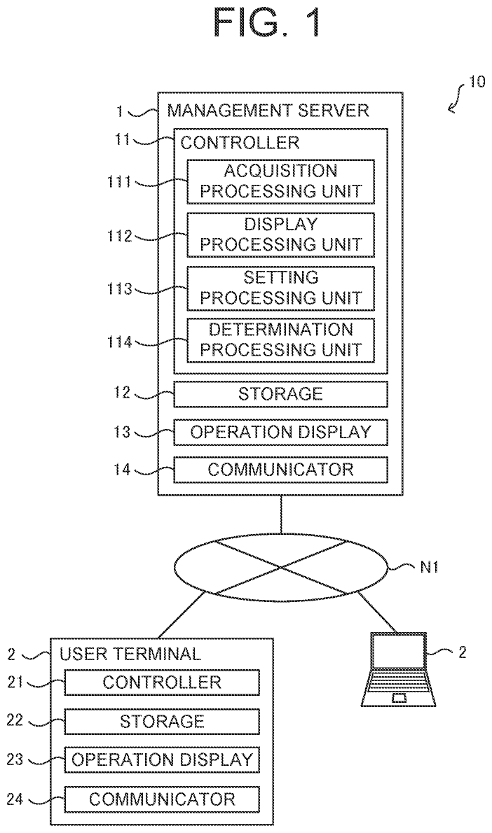

FIG. 1 is a block diagram illustrating a configuration of a meeting information management system 10 according to an embodiment of the present disclosure. The meeting information management system 10 includes a management server 1 and a user terminal 2. The management server 1 and the user terminal 2 are connected to each other via a network N1 (for example, the Internet or a local area network (LAN)). The meeting information management system 10 may include a plurality of user terminals 2.

In the meeting information management system 10, the management server 1 manages minutes (an example of minutes information according to the present disclosure) to be uploaded from the user terminal 2. Further, the management server 1 provides a user with a service (meeting support service) such as holding a meeting, creating minutes of a meeting, and managing minutes. Note that, the management server 1 may acquire audio data of a meeting from the user terminal 2 or another server, and create minutes in the form of text from the audio data.

For example, the management server 1 receives a reservation for a meeting, or holds a meeting (such as an online meeting or a Web meeting) by connecting the user terminals 2 to each other. In addition, the management server 1 creates minutes by causing the user terminal 2 to display a screen for creating minutes of a meeting, and receiving an operation of inputting a minutes content from the user, and stores the created minutes in a storage 12. Further, the management server 1 manages the minutes stored in the storage 12 in such a way as to be accessible from the user, and causes the user terminal 2 to display information (minutes list) on a plurality of minutes in response to access from the user.

Each user of the plurality of user terminals 2 uploads data (such as a file) such as minutes created in the user terminal 2 of the user to the management server 1 by utilizing a predetermined application (meeting support application). Further, each user can access the management server 1 by utilizing the meeting support application, browse each minutes, browse relevant information (a minutes list) on a plurality of minutes, and download desired minutes to the user terminal 2.

The meeting information management system 10 is an example of a meeting information management system according to the present disclosure. Note that, the meeting information management system according to the present disclosure may be constituted of the management server 1 alone.

Management Server 1

As illustrated in FIG. 1, the management server 1 includes a controller 11, the storage 12, an operation display 13, a communicator 14, and the like. The management server 1 may be one or more cloud servers, or one or more physical servers.

The communicator 14 is a communication interface for connecting the management server 1 to the network N1 in a wired or wireless manner, and performing data communication with the user terminal 2 via the network N1 in accordance with a predetermined communication protocol. The network N1 is constituted, for example, of the Internet or a LAN.

The operation display 13 is a user interface including a display such as a liquid crystal display or an organic EL display that displays various pieces of information, and an operation acceptor such as a mouse, a keyboard, or a touch panel that receives an operation.

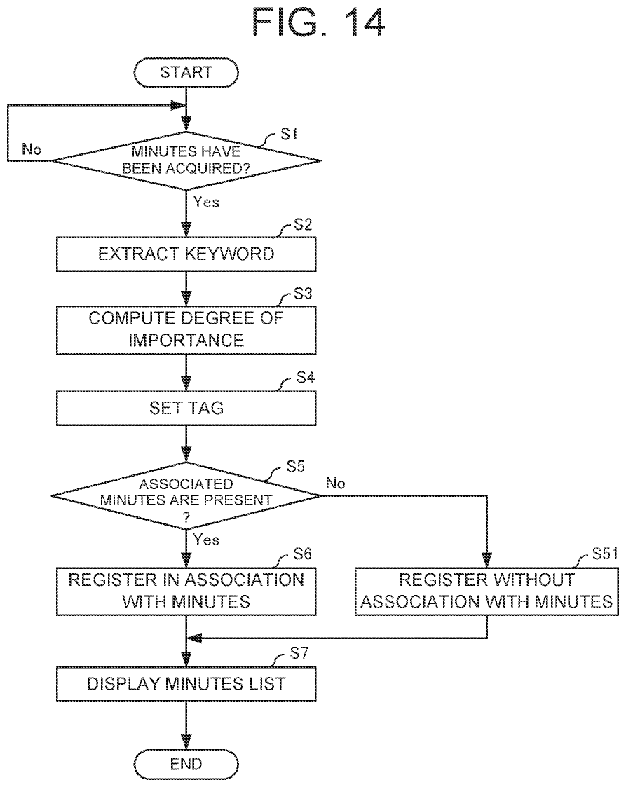

The storage 12 is a non-volatile storage such as a hard disk drive (HDD), a solid state drive (SSD), or a flash memory, which stores various pieces of information. The storage 12 stores a control program such as a meeting information management program for causing the controller 11 to perform meeting information management processing (see FIG. 14) to be described later. For example, the meeting information management program is non-transitorily recorded in a computer-readable recording medium such as a CD, or a DVD, read by a reading device (not illustrated) such as a CD drive or a DVD drive included in the management server 1, and stored in the storage 12. Note that, the meeting information management program may be distributed from a cloud server, and stored in the storage 12.

The storage 12 also stores data such as minutes M1 to be acquired from the user terminal 2, and meeting information D1 related to the minutes M1.

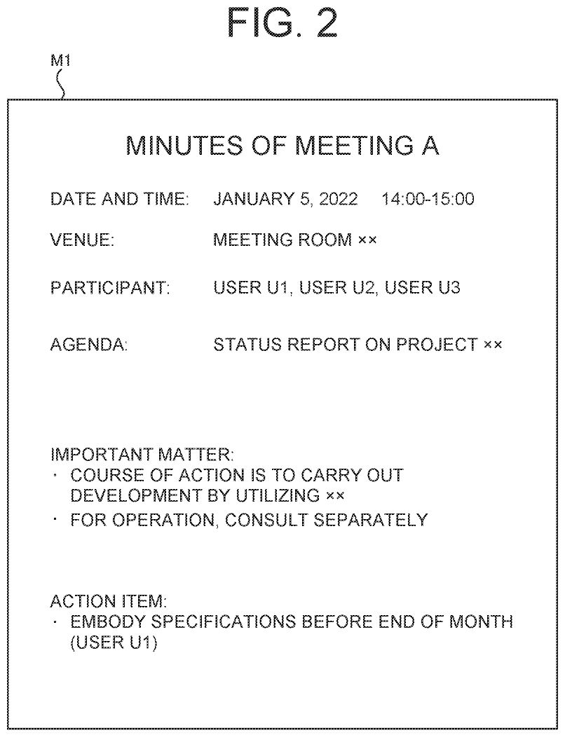

FIG. 2 illustrates an example of the minutes M1. The minutes M1 illustrated in FIG. 2 are minutes related to a meeting A, and the user who participates in the meeting A creates the minutes M1 in the user terminal 2 during the meeting or after the meeting is over. The minutes M1 include information such as a date and time of holding the meeting A, a venue, participants, an agenda, and an important matter. When the user creates the minutes M1 in the user terminal 2, the user activates the meeting support application, and uploads the minutes M1 to the management server 1. When the controller 11 acquires the minutes M1, the controller 11 stores the minutes M1 in the storage 12. As another embodiment, the controller 11 may acquire audio data of a meeting, and create minutes M1 in a text format by performing voice recognition of the audio data.

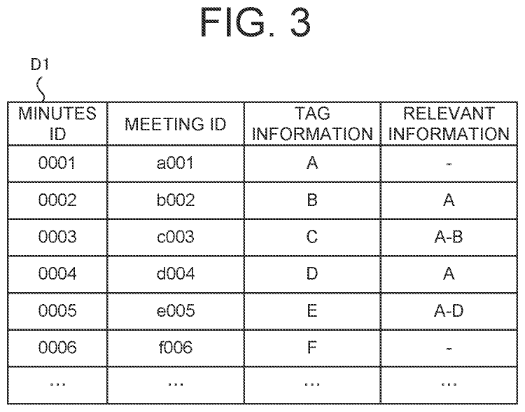

FIG. 3 illustrates an example of the meeting information D1. In the meeting information D1, information related to the minutes M1 is registered in association for each meeting. Specifically, a minutes ID, a meeting ID, tag information, and relevant information are registered in the meeting information D1. The minutes ID is identification information of the minutes M1, and is associated with the minutes M1 stored in the storage 12. For example, a minutes identifier “0001” is associated with the minutes M1 of the meeting A illustrated in FIG. 2. The meeting ID is identification information of a meeting. For example, a meeting identifier “a001” is associated with the meeting A. The tag information is information to be set for the minutes M1, and is, for example, a feature element (hereinafter, referred to as a “tag”) representing a feature of a meeting, such as a meeting name, an agenda, and an important keyword within the minutes M1. The controller 11 sets a tag, based on the minutes M1 of a meeting, and registers the tag in the tag information of the meeting information D1 in association with the minutes M1. Hereinafter, text information is described as an example of the tag (feature element), but the tag may be image information or audio information.

The relevant information is information indicating relevance of a plurality of meetings. For example, in a case where a meeting B is associated with the meeting A, tag information “A” associated with the meeting A is registered in the relevant information of the minutes M1 (minutes ID “0002”) of the meeting B. Further, for example, in a case where a meeting C is associated with each of the meeting A and the meeting B, the tag information “A” associated with the meeting A, and tag information “B” associated with the meeting B are registered in the relevant information of the minutes M1 (minutes ID “0003”) of the meeting C. The controller 11 determines relevance of a plurality of meetings, based on each minutes, and registers the relevance in the relevant information of the meeting information D1.

Note that, the minutes M1 and the meeting information D1 may be registered in a data server different from the management server 1. The data server may manage the minutes M1 and the meeting information D1, and the management server 1 may refer to the minutes M1 and the meeting information D1 by accessing the data server.

The controller 11 includes a control device such as a CPU, a ROM, and a RAM. The CPU is a processor that executes various arithmetic operations. The ROM stores in advance a control program such as a BIOS and an OS for causing the CPU to execute various pieces of processing. The RAM stores various pieces of information, and is used as a temporary storage memory (work area) in which the CPU executes various pieces of processing. The controller 11 also controls the management server 1 by causing the CPU to execute various control programs stored in advance in the ROM or the storage 12.

Specifically, as illustrated in FIG. 1, the controller 11 includes various processing units such as an acquisition processing unit 111, a display processing unit 112, a setting processing unit 113, and a determination processing unit 114. Note that, the controller 11 functions as the various processing units by executing various pieces of processing according to the meeting information management program. Also, some or all of the processing units included in the controller 11 may be constituted of an electronic circuit. Note that, the meeting information management program may be a program for causing a plurality of processors to function as the various processing units.

The acquisition processing unit 111 acquires the minutes M1 of a meeting. Specifically, when the user creates the minutes M1 (see FIG. 2) in the user terminal 2, and performs an upload operation, the acquisition processing unit 111 acquires the minutes M1. Note that, the minutes M1 may be created in a Web application (meeting support application) to be provided by the management server 1, or may be created in an application (meeting support application) installed in the user terminal 2. The acquisition processing unit 111 acquires the minutes M1 to be created for each meeting, and stores the minutes in the storage 12.

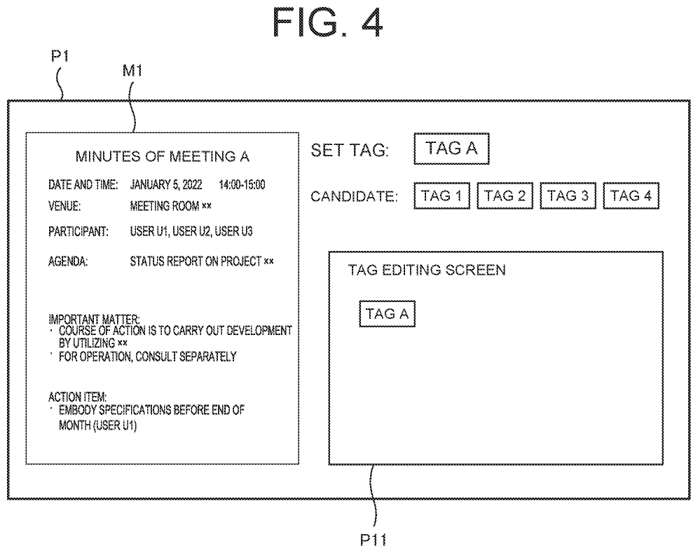

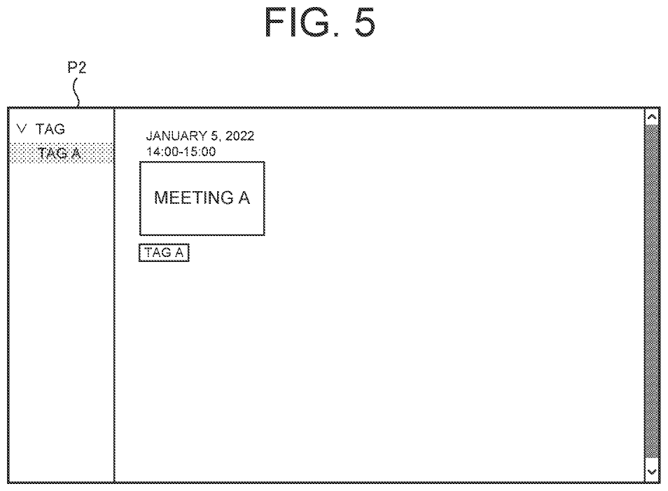

The display processing unit 112 causes the user terminal 2 to display various pieces of information. For example, the display processing unit 112 causes the user terminal 2 to display a creation screen for creating the minutes M1. Further, for example, the display processing unit 112 causes the user terminal 2 to display a tag setting screen P1 for setting a tag for the minutes M1. Further, for example, the display processing unit 112 causes the user terminal 2 to display a minutes list screen P2 indicating a minutes list. FIG. 4 illustrates an example of the tag setting screen P1, and FIG. 5 illustrates an example of the minutes list screen P2.

The setting processing unit 113 sets a tag for the minutes M1. Specifically, the setting processing unit 113 determines a tag representing a feature of the minutes M1, based on the minutes M1, and sets (assigns) the determined tag to the minutes M1.

For example, the setting processing unit 113 extracts, from the minutes M1 (see FIG. 2), a plurality of keywords related to a minutes content, such as a meeting name, an agenda, an important matter, and an action item. The setting processing unit 113 computes a degree of importance for each of a plurality of extracted keywords, based on information such as an appearance frequency (the number of times of appearance), and a position (rank) of a speaker. For example, the setting processing unit 113 computes a degree of importance of a keyword to be higher, as the number of times of appearance increases. The setting processing unit 113 determines a keyword having a highest degree of importance, as a tag, and sets (assigns) the determined tag to the minutes M1.

In the minutes M1 illustrated in FIG. 2, the setting processing unit 113 determines a keyword “A” having a highest degree of importance, as a tag, and sets the determined tag A for the minutes M1. The display processing unit 112 causes to display the set tag A on the tag setting screen P1 (see FIG. 4). Further, the display processing unit 112 causes to display, on the tag setting screen P1, a plurality of tag candidates (for example, top four tags) in descending order of a degree of importance among the plurality of keywords. In addition, when the setting processing unit 113 sets a tag for the minutes M1, the display processing unit 112 may cause to display, in the minutes M1, a character string corresponding to the tag in an identifiable manner (such as highlight display).

The user can confirm a set tag on the tag setting screen P1 to be displayed on the user terminal 2. Further, the user can change the set tag on the tag setting screen P1 to any of a plurality of tag candidates. In a case where an operation of changing the set tag is received from the user, the setting processing unit 113 sets the tag selected by the user for the minutes M1. Further, in a case where the setting processing unit 113 receives the changing operation, the display processing unit 112 may cause to display, in the minutes M1, a character string corresponding to a tag after the change, and a character string corresponding to a tag before the change in an identifiable manner (such as highlight display in a different color).

The setting processing unit 113 registers, in the meeting information D1 (see FIG. 3), the determined tag in association with the minutes M1 of the meeting A. Further, when the setting processing unit 113 sets a tag for the minutes M1, the display processing unit 112 causes the user terminal 2 to display the minutes list screen P2 (see FIG. 5). An object image (for example, an icon) associated with the minutes M1 is displayed on the minutes list screen P2, and a meeting date and time, and a set tag are displayed in association with the object image. In FIG. 5, an object image of the meeting A, the tag A set for the minutes M1 of the meeting A, and a date and time of holding the meeting A are displayed in association with one another. Note that, when the object image of the meeting A is selected (touched) on the minutes list screen P2 displayed on the user terminal 2 by the user, the display processing unit 112 may cause the user terminal 2 to display the minutes M1 (see FIG. 2) of the meeting A, or the tag setting screen P1 (see FIG. 4).

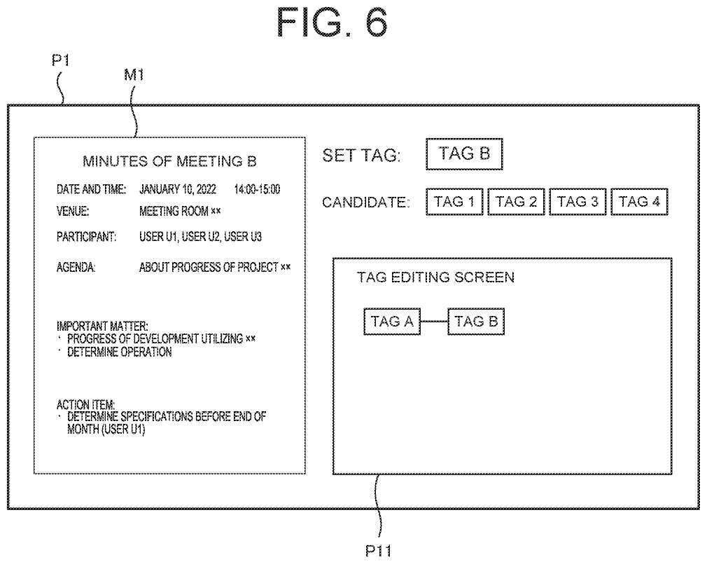

FIG. 6 illustrates the tag setting screen P1 related to the minutes M1 of another meeting (meeting B). In the minutes M1 illustrated in FIG. 6, the setting processing unit 113 determines a keyword “B” having a highest degree of importance, as a tag, and sets the determined tag B for the minutes M1. The display processing unit 112 causes the tag setting screen P1 (see FIG. 6) to display the set tag B. In the meeting information D1 (see FIG. 3), the setting processing unit 113 registers the determined tag in association with the minutes M1 of the meeting B.

In this way, the setting processing unit 113 sets one tag for one minutes M1. As another embodiment, the setting processing unit 113 may set a plurality of tags for one minutes M1. Herein, in a case where the acquisition processing unit 111 acquires a plurality of minutes M1, in other words, in a case where a plurality of minutes M1 are stored in the storage 12, the determination processing unit 114 determines whether each of the plurality of minutes M1 is associated with each other. Specifically, the determination processing unit 114 computes a degree of similarity of each of a plurality of minutes M1, based on information (for example, a keyword related to a minutes content such as a meeting name, an agenda, an important matter, and an action item) included in each minutes M1, and determines that each of the plurality of minutes M1 is associated with each other, in a case where the degree of similarity is equal to or more than a threshold value.

For example, in a case where the acquisition processing unit 111 acquires the minutes M1 of the meeting A and the minutes M1 of the meeting B, the determination processing unit 114 computes a degree of similarity between the two minutes M1, based on information on each minutes M1. Further, in a case where the degree of similarity is equal to or more than a threshold value, the determination processing unit 114 determines that the two minutes M1 (two meetings) are associated with each other.

For example, when the meeting B is held after the meeting A is held, the setting processing unit 113 sets the tag B for the minutes M1 of the meeting B on the tag setting screen P1 (see FIG. 6). When the tag B is set for the minutes M1 of the meeting B, the determination processing unit 114 determines whether the minutes M1 of the meeting B are associated with the minutes M1 (see FIGS. 4 and 5) of the meeting A that has already been registered. When the determination processing unit 114 determines that the minutes M1 of the meeting B are associated with the minutes M1 of the meeting A (the meeting B is associated with the meeting A), the setting processing unit 113 associates the tag B set for the minutes M1 of the meeting B with the tag A set for the minutes M1 of the meeting A. Specifically, the setting processing unit 113 registers the tag information “A” in the relevant information (see FIG. 3) of the minutes M1 (minutes ID “0002”) of the meeting B.

The display processing unit 112 causes to display, on a tag editing screen P11 of the tag setting screen P1, information related to a set tag. For example, as illustrated in FIG. 4, in a case where there is no past meeting associated with the meeting A, the display processing unit 112 causes to display, on the tag editing screen P11, only the tag A set for the minutes M1 of the meeting A. In addition, for example, as illustrated in FIG. 6, in a case where the meeting A is a meeting associated with the meeting B, the display processing unit 112 causes to display, on the tag editing screen P11, the tag B set for the minutes M1 of the meeting B in association with the tag A set for the minutes M1 of the meeting A that is determined to be associated with the meeting B. For example, the display processing unit 112 causes to display (hierarchical display) the tag B on a lower layer (second layer) of the tag A on a first layer. Further, in a case where a plurality of meetings are associated with each other, the display processing unit 112 may cause to display, on the tag editing screen P11, a plurality of tags associated with each meeting in association with each other in a time-series manner. This allows the user to easily recognize, on the tag editing screen P11, a flow of a topic in a meeting, a feature (important point) of each meeting, and the like.

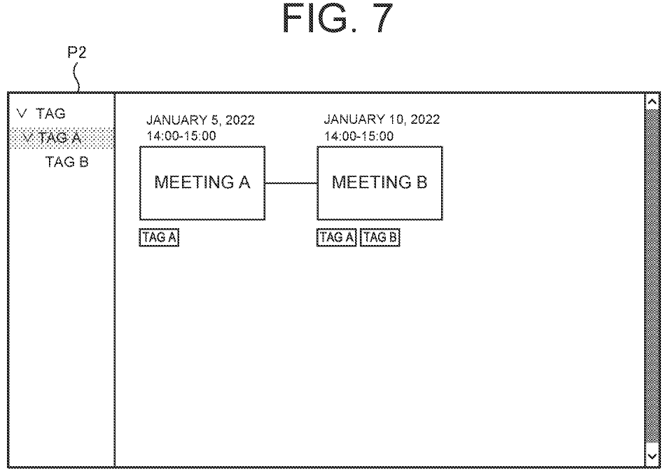

Further, as illustrated in FIG. 7, the display processing unit 112 causes to display, on the minutes list screen P2, relevance of each meeting in an identifiable manner. For example, in a case where the meeting A and the meeting B are associated with each other, the display processing unit 112 causes to display an object image of the meeting B on a lower layer (second layer) of the object image of the meeting A whose meeting date and time is earlier (in the past). Further, the display processing unit 112 causes to display the tag A set for the minutes M1 of the meeting A, and the tag B set for the minutes M1 of the meeting B in association with the object image of the meeting B.

In this way, in a case where the minutes M1 of the meeting A, and the minutes M1 of the meeting B are associated with each other, the display processing unit 112 causes to display the object image of the meeting A, and the object image of the meeting B in order according to the date and time of holding the meeting, causes to display the tag A associated with the minutes M1 of the meeting A in association with the object image of the meeting A, and causes to display the tag A associated with the minutes M1 of the meeting A, and the tag B associated with the minutes M1 of the meeting B in association with the object image of the meeting B. This allows the user to easily recognize that the meeting A and the meeting B are associated with each other, a flow of a topic in the meeting A and the meeting B, a feature (important point) of each meeting, and the like by checking the minutes list screen P2.

As described above, in a case where the first minutes M1 and the second minutes M1 are associated with each other, the setting processing unit 113 sets a different tag from each other for each of the first minutes M1 and the second minutes M1. Note that, as another embodiment, in a case where the first minutes M1 and the second minutes M1 are associated with each other, the setting processing unit 113 may set the same tag for each of the first minutes M1 and the second minutes M1.

Herein, in a case where a meeting D is further held after the meeting B, and in a case where the minutes M1 of the meeting D are similar to the minutes M1 of the meeting A, and are not similar to the minutes M1 of the meeting B, the determination processing unit 114 determines that the minutes M1 of the meeting D are associated with the minutes M1 of the meeting A (the meeting D is associated with the meeting A), and are not associated with the minutes M1 of the meeting B (the meeting D is not associated with the meeting B). In this case, the setting processing unit 113 associates a tag D set for the minutes M1 of the meeting D with the tag A set for the minutes M1 of the meeting A, and does not associate the tag D with the tag B set for the minutes M1 of the meeting B. The setting processing unit 113 registers the tag information “A” in the relevant information (see FIG. 3) of the minutes M1 (minutes ID “0004”) of the meeting D.

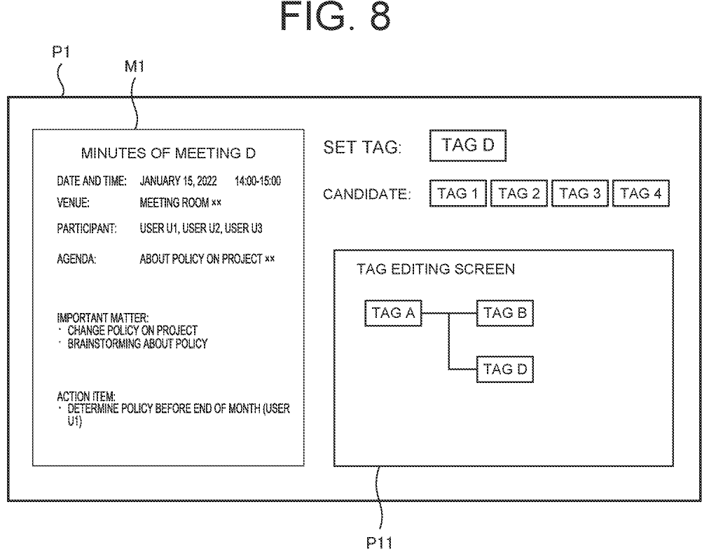

In this case, for example, as illustrated in FIG. 8, the display processing unit 112 causes to display, on the tag editing screen P11, the tag D set for the minutes M1 of the meeting D in a state that the tag D is associated with the tag A set for the minutes M1 of the meeting A, and is not associated with the tag B set for the minutes M1 of the meeting B. For example, the display processing unit 112 causes to display the tag D on a lower layer of the tag A, and on the same layer (second layer) as the tag B.

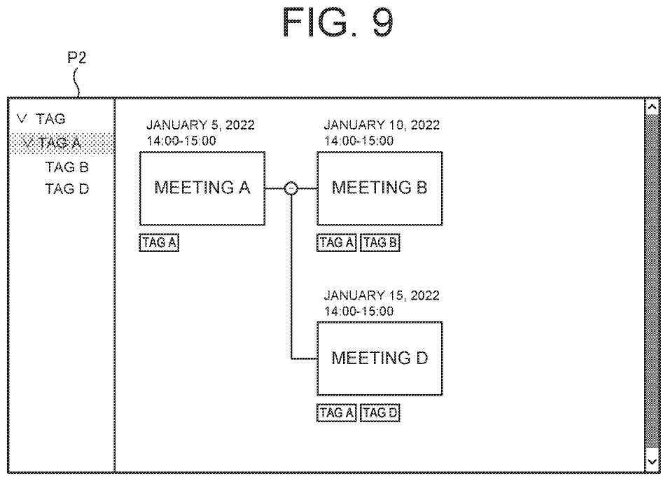

Further, as illustrated in FIG. 9, the display processing unit 112 causes to display, on the minutes list screen P2, the object image of the meeting D on a lower layer of the object image of the meeting A having an earlier meeting date and time, and on the same layer (second layer) as the object image of the meeting D. Further, the display processing unit 112 causes to display the tag A set for the minutes M1 of the meeting A, and the tag D set for the minutes M1 of the meeting D in association with the object image of the meeting D. In this way, in a case where the minutes M1 of the meeting A and the minutes M1 of the meeting B are associated with each other, the minutes M1 of the meeting A and the minutes M1 of the meeting D are associated with each other, and the minutes M1 of the meeting B and the minutes M1 of the meeting D are not associated with each other, the display processing unit 112 causes to display the object image of the meeting A on the first layer, and causes to display the object image of the meeting B and the object image of the meeting D in parallel on the second layer below the first layer.

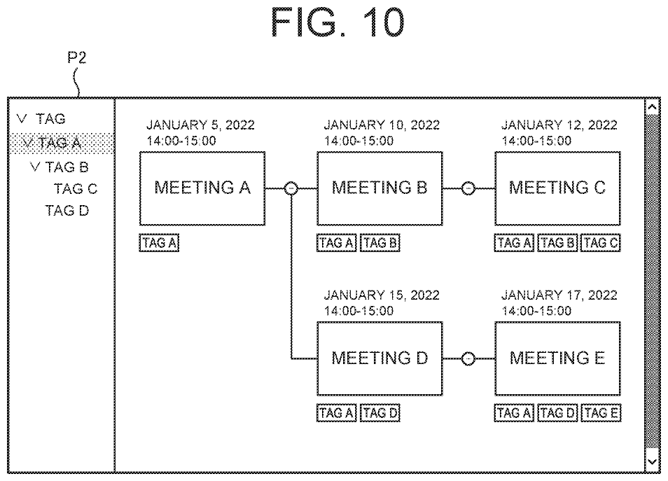

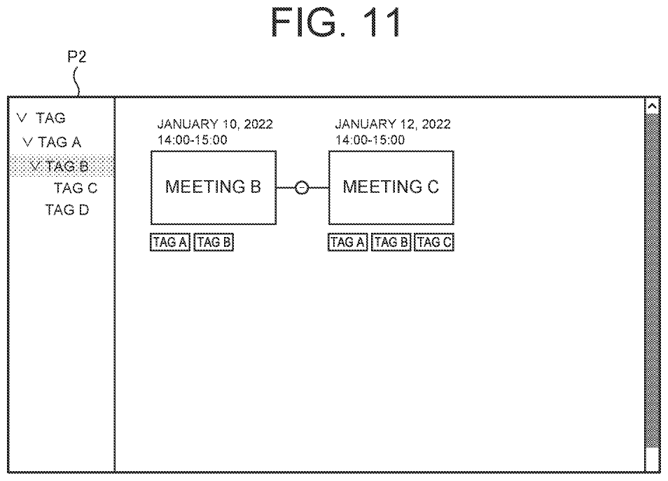

FIG. 10 illustrates the minutes list screen P2 representing relevance of five meetings further including other meetings (a meeting C and a meeting E). Since the meeting C is associated with the meeting A and the meeting B, is not associated with the meeting D and the meeting E, and has a later meeting date and time than that of the meeting B, the object image of the meeting C is displayed on a lower layer (third layer) of the object image of the meeting B. Further, the tag A, the tag B, and a tag C are displayed in association with the object image of the meeting C. In addition, since the meeting E is associated with the meeting A and the meeting D, is not associated with the meeting B and the meeting C, and has a later meeting date and time than that of the meeting D, the object image of the meeting E is displayed on a lower layer (third layer) of the object image of the meeting D. Further, the tag A, the tag D, and a tag E are displayed in association with the object image of the meeting E. Note that, the meeting information D1 illustrated in FIG. 3 is associated with the state illustrated in FIG. 10. Herein, a display content of the minutes list screen P2 is updated according to a tag selected by the user. For example, when the user selects “tag A” in a tag selection area on the left side of the minutes list screen P2, as illustrated in FIG. 10, the display processing unit 112 extracts the minutes M1 to which the “tag A” is assigned from a plurality of minutes M1, and causes to display the extracted minutes in a list (list display) on the minutes list screen P2. For example, when the user selects the “tag B” in the tag selection area on the left side of the minutes list screen P2, as illustrated in FIG. 11, the display processing unit 112 extracts the minutes M1 to which the “tag B” is assigned from a plurality of minutes M1, and causes to display the extracted minutes in a list on the minutes list screen P2. The user can switch the minutes list screen P2 by selecting a desired tag.

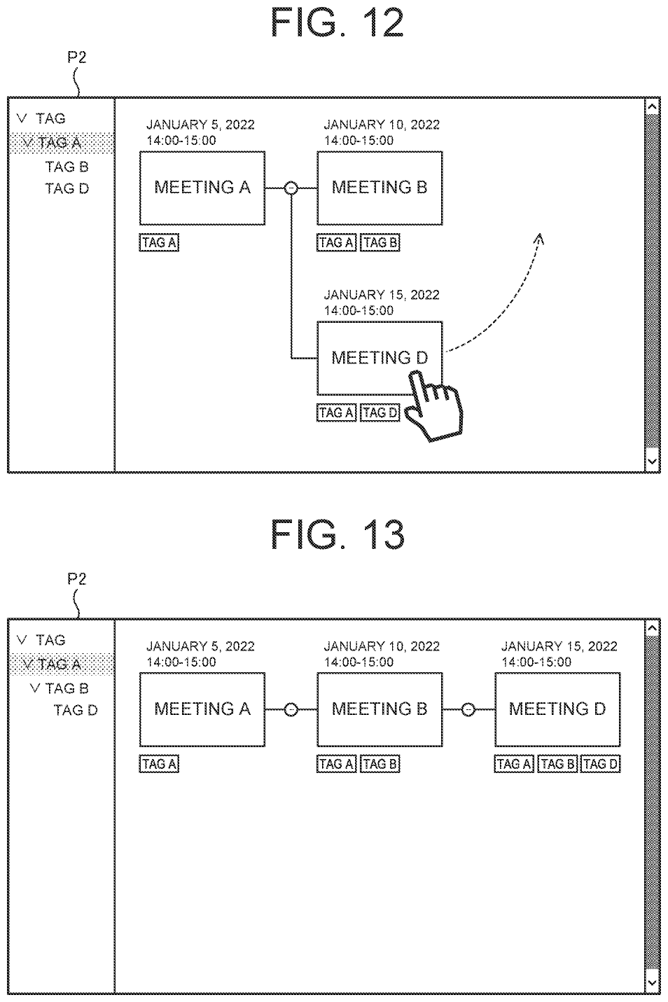

Further, the user can change relevance of a meeting (minutes M1) on the minutes list screen P2. For example, as illustrated in FIG. 12, in a case where the system is set to a state that the meeting D is associated with the meeting A, and is not associated with the meeting B, and in a case where the user desires to associate the meeting D with the meeting B, the user performs an operation of changing the relevance of the meeting. For example, as illustrated in FIG. 12, the user performs an operation (for example, a drag-and-drop operation) of moving the object image (icon) of the meeting D to a lower layer of the meeting B. This allows the setting processing unit 113 to add the tag B for the minutes M1 of the meeting D in the relevant information (see FIG. 3). As illustrated in FIG. 13, the display processing unit 112 causes to display the object image of the meeting D on a lower layer (third layer) of the meeting B, and causes to display the tag A, the tag B, and the tag D in association with the object image of the meeting D. In this way, the user can change relevant information set by the controller 11. As described above, the management server 1 determines a tag representing a feature of the minutes M1, based on the minutes M1, sets the determined tag for the minutes M1, and, in a case where a plurality of minutes M1 for which the tag is set are associated with each other, causes to display the plurality of minutes M1, and the tag associated with each of the minutes M1 in an identifiable manner.

User Terminal 2

As illustrated in FIG. 1, the user terminal 2 includes a controller 21, a storage 22, an operation display 23, a communicator 24, and the like. The user terminal 2 is an information processing device such as, for example, a laptop computer, a smartphone, or a tablet terminal.

The communicator 24 is a communication interface for connecting the user terminal 2 to the network N1 in a wired or wireless manner, and for performing data communication between the user terminal 2 and an external device such as the management server 1 via the network N1 in accordance with a predetermined communication protocol.

The operation display 23 is a user interface including a display such as a liquid crystal display or an organic EL display that displays information such as various Web pages, and an operation acceptor such as a mouse, a keyboard, or a touch panel that receives an operation. The storage 22 is a non-volatile storage such as an HDD, an SSD, or a flash memory that stores various pieces of information. For example, the storage 22 stores a control program such as a browser program. Specifically, the browser program is a control program for causing the controller 21 to perform communication processing with an external device such as the management server 1 in accordance with a communication protocol such as a hypertext transfer protocol (HTTP). Further, the browser program may be a dedicated application for performing communication processing with the management server 1 in accordance with a predetermined communication protocol.

The controller 21 includes a control device such as a CPU, a ROM, and a RAM. The CPU is a processor that executes various arithmetic processing. The ROM is a non-volatile storage in which a control program such as a BIOS and an OS for causing the CPU to execute various arithmetic processing is stored in advance. The RAM is a volatile or non-volatile storage that stores various pieces of information, and is used as a temporary storage memory (work area) in which the CPU executes various pieces of processing. Further, the controller 21 controls the user terminal 2 by causing the CPU to execute various control programs stored in advance in the ROM or the storage 22.

Specifically, the controller 21 functions as a browser processing unit by performing various pieces of processing in accordance with the browser program stored in the storage 22. The controller 21 can perform browser processing of causing the operation display 23 to display a Web page to be provided from the management server 1 via the network N1, and inputting an operation for the operation display 23 to the management server 1. Specifically, the user terminal 2 can function as an operation terminal of the management server 1 when the browser program is executed by the controller 21. Note that, a part or all of the processing units included in the controller 21 may be constituted of an electronic circuit.

In a case where a user operation for requesting an access to a predetermined URL associated with a site of the meeting support service to be provided by the management server 1 is performed on the user terminal 2, the controller 21 acquires data on a Web page of the site from the management server 1, and causes the operation display 23 to display the Web page of the site. Note that, in a case where a predetermined application (meeting support application) associated with the management server 1 is installed in the user terminal 2, the Web page of the site is displayed on the operation display 23 when the user of the user terminal 2 performs an operation of activating the meeting support application.

In addition, the controller 21 uploads the minutes M1 created and stored in the user terminal 2 to the management server 1 in response to a user operation. In addition, the controller 21 transmits, to the management server 1, a search request for searching for the minutes M1 stored in the management server 1 in response to a user operation. In addition, the controller 21 causes to display a result of search processing by the management server 1. Also, the controller 21 causes to display a content of the minutes M1, or downloads the content to the user terminal 2 in response to an operation of selecting the minutes M1 included in a search result.

In addition, the controller 21 causes the operation display 23 of the user terminal 2 to display a Web page such as the tag setting screen P1 (see FIGS. 4, 6, and 8), and the minutes list screen P2 (see FIGS. 5, 7, and 9 to 13). In addition, the controller 21 receives a user operation in each page.

Meeting Information Management Processing

Hereinafter, an example of a procedure of meeting information management processing to be performed in the meeting information management system 10 is described with reference to FIG. 14.

Note that, the present disclosure can be described as a meeting information management method of executing one or a plurality of steps included in the meeting information management processing. Further, one or more steps included in the meeting information management processing described herein may be omitted as necessary. Further, the order of execution of each step in the meeting information management processing may be different, as far as similar advantageous effects are generated. Furthermore, although a case is described herein as an example, in which the controller 11 of the management server 1 executes each step in the meeting information management processing, in another embodiment, one or more processors may execute each step in the meeting information management processing in a distributed manner.

First, in step S1, the controller 11 determines whether minutes M1 have been acquired from the user terminal 2 or another server. Upon acquiring the minutes M1 from the user terminal 2 (S1:Yes), the controller 11 shifts the processing to step S2. The controller 11 waits until the minutes M1 are acquired from the user terminal 2 (S1:No).

In step S2, the controller 11 extracts, from the minutes M1, a plurality of keywords related to a minutes content such as a meeting name, an agenda, an important matter, and an action item. Herein, the minutes M1 may be a document file, an image file, or an audio file. The controller 11 extracts a keyword by searching for a word or a character from text information of a document file. In addition, the controller 11 extracts a keyword by converting an image into text information, and searching for a word or a character. In addition, the controller 11 extracts a keyword by converting voice into text, and searching for a word or a character. Note that, the controller 11 may extract the keyword by collating a plurality of registered words registered in advance.

Next, in step S3, the controller 11 computes a degree of importance of the extracted keyword. Specifically, the controller 11 computes a degree of importance of each of a plurality of extracted keywords, based on information such as an appearance frequency (the number of times of appearance), and a position (rank) of a speaker. For example, the controller 11 computes a degree of importance of a keyword to be higher, as the number of times of appearance increases.

Next, in step S4, the controller 11 sets a tag for the minutes M1. Specifically, the controller 11 determines, as a tag, a keyword having a highest degree of importance from among a plurality of extracted keywords, and sets (assigns) the determined tag to the minutes M1.

As another embodiment, the controller 11 may set a tag for the minutes M1 in response to a user operation. For example, the user performs an operation of changing a set tag to any one of a plurality of tag candidates on the tag setting screen P1 (see FIGS. 4, 6, and 8). In a case where the controller 11 receives an operation of changing a set tag by the user, the controller 11 sets the tag selected by the user for the minutes M1.

When a tag is set for the minutes M1, the controller 11 registers the tag in tag information of the meeting information D1 (see FIG. 3).

Next, in step S5, the controller 11 determines whether there are past minutes M1 associated with the minutes M1 acquired in step S1. Specifically, the controller 11 determines whether minutes M1 associated with the minutes M1 acquired in step S1 are present among a plurality of minutes M1 stored in the storage 12. The controller 11 computes a degree of similarity between the minutes M1, based on information (a minutes content such as a meeting name, an agenda, an important matter, and an action item) included in each minutes M1, and determines whether there are minutes M1 whose degree of similarity is equal to or more than a threshold value. When the controller 11 determines that there are minutes M1 whose degree similarity is equal to or more than the threshold value, the controller 11 determines that there are minutes M1 associated with the minutes M1 acquired in step S1.

In a case where it is determined that minutes M1 associated with the minutes M1 acquired in step S1 are present (S5:Yes), the controller 11 shifts the processing to step S6. On the other hand, in a case where the controller 11 determines that minutes M1 associated with the minutes M1 acquired in step S1 are not present (S5:No), the controller 11 shifts the processing to step S51.

In step S6, the controller 11 registers the minutes M1 acquired in step S1, and past minutes M1 that are determined to be associated with the minutes M1 in step S5 in association with each other. For example, in a case where acquired minutes M1 of the meeting B are associated with the minutes M1 of the meeting A stored in the storage 12, the controller 11 registers both of the minutes M1 in association with each other. Specifically, in the meeting information D1 (see FIG. 3), the controller 11 registers the tag information (“A”) set for the minutes M1 of the meeting A in relevant information associated with the minutes M1 of the meeting B. This allows the meeting A and the meeting B to be associated with each other.

Further, for example, in a case where the acquired minutes M1 of the meeting C are associated with each of the past minutes M1 of the meeting A and the past minutes M1 of the meeting B stored in the storage 12, the controller 11 registers these minutes M1 in association with one another. Specifically, in the meeting information D1 (see FIG. 3), the controller 11 registers the tag information (“A”) set for the minutes M1 of the meeting A, and the tag information (“B”) set for the minutes M1 of the meeting B in relevant information associated with the minutes M1 of the meeting C. This allows the meeting A, the meeting B, and the meeting C to be associated with one another. After step S6, the controller 11 shifts the processing to step S7.

On the other hand, in step S51, the controller 11 registers the minutes M1 acquired in step S1 in the meeting information D1 (see FIG. 3) without associating the minutes M1 with other minutes M1. For example, in a case where the acquired minutes M1 of the meeting A are not associated with any of the other minutes M1 stored in the storage 12, the controller 11 registers the minutes M1 of the meeting A without associating the minutes M1 with other minutes M1. Specifically, in the meeting information D1 (see FIG. 3), the controller 11 does not register tag information in relevant information associated with the minutes M1 of the meeting A. After step S51, the controller 11 shifts the processing to step S7.

In step S7, the controller 11 causes the user terminal 2 to display the minutes list screen P2 representing a minutes list. For example, in a case where the minutes M1 of the meeting A are acquired, the controller 11 causes the user terminal 2 to display the minutes list screen P2 illustrated in FIG. 5. Further, for example, in a case where the minutes M1 of the meeting B are acquired, the controller 11 causes the user terminal 2 to display the minutes list screen P2 illustrated in FIG. 7. The controller 11 causes to display the object image of the meeting B on a lower layer (second layer) of the object image of the meeting A having an earlier meeting date and time, and causes to display the tag A set for the minutes M1 of the meeting A, and the tag B set for the minutes M1 of the meeting B in association with the object image of the meeting B.

Further, for example, in a case where the controller 11 acquires the minutes M1 of the meeting C, as illustrated in FIG. 10, the controller 11 causes to display the object image of the meeting C on a lower layer (third layer) of the object image of the meeting B having an earlier meeting date and time, and causes to display the tag A set for the minutes M1 of the meeting A, the tag B set for the minutes M1 of the meeting B, and the tag C set for the minutes M1 of the meeting C in association with the object image of the meeting C.

As described above, the controller 11 performs the meeting information management processing. The controller 11 performs the meeting information management processing each time the minutes M1 are acquired from each of the user terminals 2.

As described above, the meeting information management system 10 according to the present embodiment acquires minutes M1 (minutes information) of a meeting, determines a tag (feature element) representing a feature of the minutes M1, based on the minutes M1, and sets the determined tag for the minutes M1. Further, in a case where a plurality of minutes M1 for which the tag is set are associated with each other, the meeting information management system 10 causes to display the plurality of minutes M1, and the tag associated with each of the minutes M1 in an identifiable manner.

According to the above configuration, for example, in a case where a meeting related to the same agenda (topic) is held a plurality of times, the minutes M1 of each meeting can be associated with each other. Therefore, when the user reviews the minutes M1 afterward, the user can easily recognize relevance of each meeting. In addition, since a tag (feature element) is assigned to each minutes M1, the user can easily recognize a feature and a degree of importance of each meeting, progress of a plurality of associated meetings, and the like.

The present disclosure is not limited to the above-described embodiment. The present disclosure may be embodied as follows.

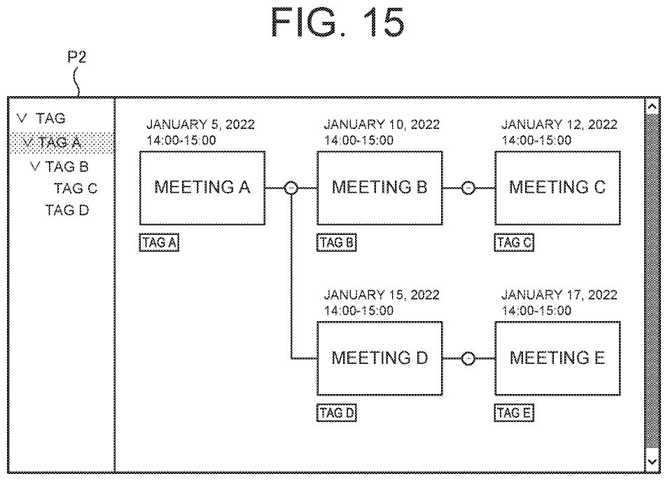

In the embodiment described above, as illustrated in FIG. 10, the controller 11 displays, for example, the tag A associated with the meeting A and the tag B associated with the meeting B in association with the meeting B on a lower layer and associated with the meeting A. As another embodiment, as illustrated in FIG. 15, the controller 11 may display, for example, only the tag B associated with the meeting B in association with the meeting B on a lower layer and associated with the meeting A. Specifically, in a case where the first minutes M1 and the second minutes M1 are associated with each other, the display processing unit 112 causes to display a first object image associated with the first minutes M1, and a second object image associated with the second minutes M1 in order according to a date and time of holding a meeting, causes to display the first tag associated with the first minutes M1 in association with the first object image, and causes to display the second tag associated with the second minutes M1 in association with the second object image. In other words, the display processing unit 112 causes to display only a tag set for the minutes M1 of each meeting with respect to an object image of each meeting.

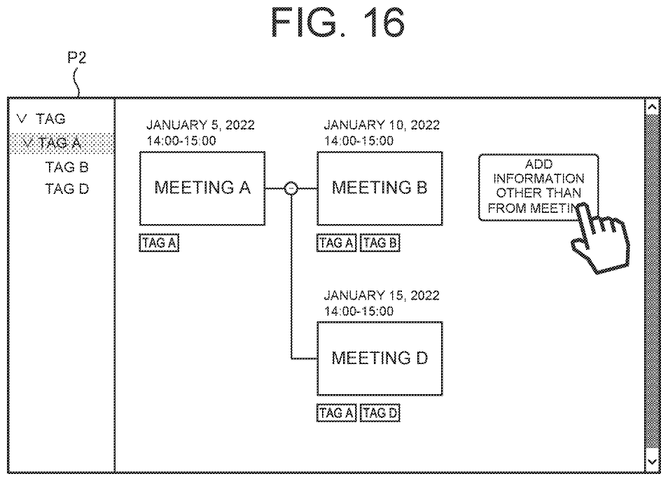

As another embodiment of the present disclosure, the controller 11 may acquire minutes information different from the minutes M1. For example, as illustrated in FIG. 16, when the user presses an “add information other than from meeting” button on the minutes list screen P2, the controller 11 acquires information other than from the meeting (for example, mail information) associated with at least one of the meeting A, the meeting B, and the meeting D, or the minutes M1. The mail information is an example of minutes information according to the present disclosure.

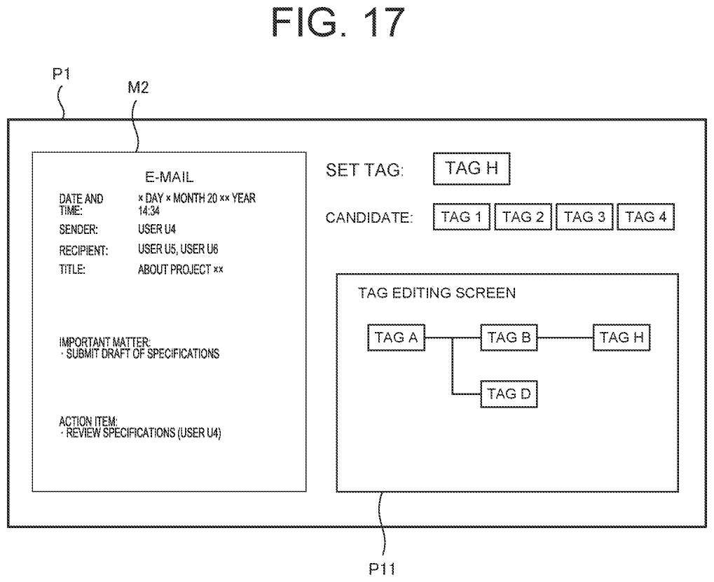

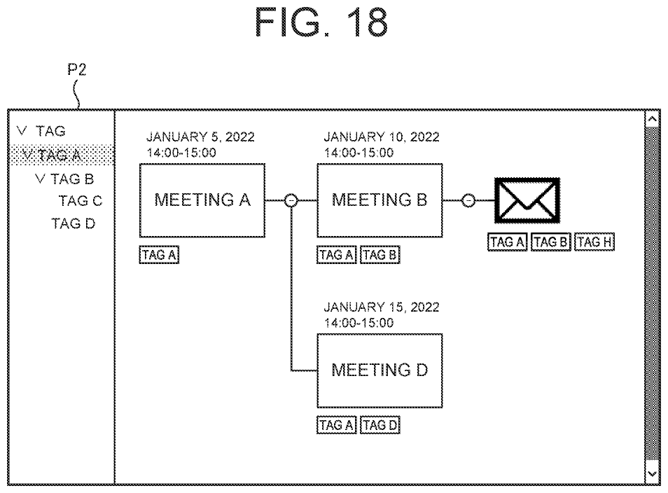

FIG. 17 illustrates an example of the mail information M2. The controller 11 sets a tag for the mail information M2. The tag setting method is the same as that of the above-described embodiment. Further, in a case where the mail information M2 is associated with the minutes M1 of at least one of the meeting A, the meeting B, and the meeting D, the controller 11 registers the mail information M2 and the minutes M1 in association with each other. For example, in a case where the mail information M2 is associated with each of the minutes M1 of the meeting A and the minutes M1 of the meeting B, as illustrated in FIG. 18, the controller 11 causes to display the object image associated with the mail information M2 on a lower layer (third layer) of the object image associated with the meeting B, and causes to display the tag A, the tag B, and a tag H in association with the object image of the mail information M2.

Note that, the controller 11 may acquire a plurality of pieces of mail information M2, and perform tag setting processing, display processing of a list indicating relevance of mails, and the like for the plurality of pieces of mail information M2.

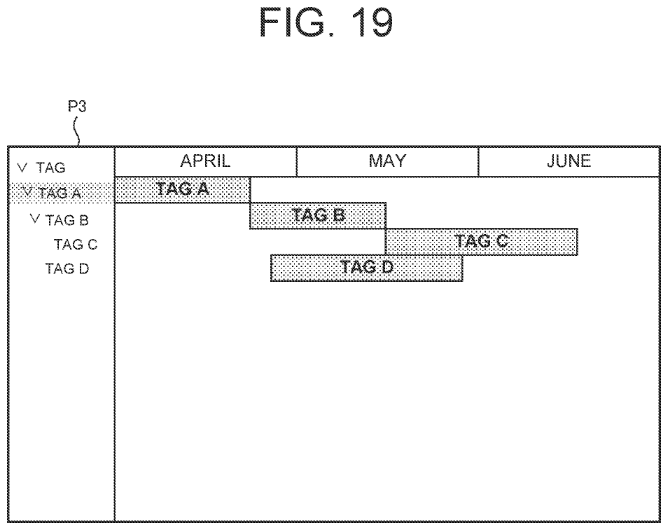

As another embodiment of the present disclosure, as illustrated in FIG. 19, the controller 11 may cause the user terminal 2 to display a chart screen P3 including a Gantt chart indicating steps of a meeting. Specifically, the controller 11 creates a Gantt chart for each tag, based on a tag, and time information (a date and time of holding a meeting, or a date and time of creating minutes) of minutes M1 to which the tag is assigned, and causes the user terminal 2 to display the chart screen P3 in response to a user operation. For example, as illustrated in FIG. 19, when the user selects the tag A, the controller 11 causes to display the tag A, and a period (a step of a meeting) of time information of the minutes M1 to which one of the tags B, C, and D associated with the tag A is assigned. This allows the user to easily recognize a time when a meeting has been held regarding a content related to a tag, which makes it possible for the user to comprehensively recognize a flow of the entire meeting.

In the above-described embodiment, the management server 1 alone is equivalent to the meeting information management system according to the present disclosure, but the meeting information management system according to the present disclosure may be constituted of the user terminal 2 alone. In this case, the user terminal 2 is configured to include, for example, functions of the management server 1 described above (functions of the acquisition processing unit 111, the display processing unit 112, the setting processing unit 113, and the determination processing unit 114). Further, the meeting information management system according to the present disclosure may be constituted of combination of the management server 1 and the user terminal 2. In this case, for example, the management server 1 is configured to include the setting processing unit 113 and the determination processing unit 114, and the user terminal 2 is configured to include the acquisition processing unit 111 and the display processing unit 112.

Note that the meeting information management system according to the present disclosure is not limited to a system that manages minutes information of a meeting, and can also be applied to a system that transmits and receives a conversation and a message in various fields such as a business negotiation and a call center.

Supplementary Note of Disclosure Hereinafter, an overview of the disclosure to be extracted from the above-described embodiment is added. Note that, each configuration and each processing function described in the following supplementary notes can be selected and optionally combined.

### Supplementary Note 1

A meeting information management system including:
an acquisition processing circuit that acquires minutes information of a meeting;
a setting processing circuit that determines a feature element representing a feature of the minutes information, based on the minutes information to be acquired by the acquisition processing circuit, and sets the determined feature element to the minutes information; and
in a case where a plurality of pieces of the minutes information to which the feature element is set by the setting processing circuit are associated with each other, a display processing circuit that causes the plurality of pieces of minutes information, and the feature element associated with each of the plurality of pieces of minutes information to be displayed in an identifiable manner.

### Supplementary Note 2

The meeting information management system according to supplementary note 1, wherein
the setting processing circuit computes a degree of importance of each of a plurality of keywords by extracting the plurality of keywords from the minutes information, and determines, as the feature element, a keyword having a highest degree of the importance.

### Supplementary Note 3

The meeting information management system according to supplementary note 1 or 2, wherein
the setting processing circuit determines, as the feature element, a keyword selected by a user from among a plurality of keywords by extracting the plurality of keywords from the minutes information.

### Supplementary Note 4

The meeting information management system according to supplementary note 2 or 3, wherein
the setting processing circuit sets the one feature element for one of the pieces of the minutes information.

### Supplementary Note 5

The meeting information management system according to any of supplementary notes 2 to 4, wherein
in a case where first minutes information and second piece of minutes information are associated with each other, the setting processing circuit sets different feature elements to the first piece of the minutes information and the second piece of the minutes information.

### Supplementary Note 6

The meeting information management system according to any of supplementary notes 1 to 5, further including
a determination processing circuit that determines whether each of a plurality of pieces of the minutes information is associated with each other, wherein the determination processing circuit computes a degree of similarity of each of a plurality of pieces of the minutes information, based on a keyword included in each of the plurality of pieces of minutes information, and, in a case where the degree of similarity is equal to or more than a threshold value, determines that each of the plurality of pieces of minutes information is associated with each other.

### Supplementary Note 7

The meeting information management system according to any of supplementary notes 1 to 6, wherein
in a case where first second pieces of minutes information are associated with each other, the display processing circuit causes a first object image associated with the first piece of the minutes information, and a second object image associated with the second piece of the minutes information to be displayed in order according to a date and time of holding the meeting, causes a first feature element associated with the first piece of the minutes information to be displayed in association with the first object image, and causes the first feature element, and a second feature element associated with the second piece of the minutes information to be displayed in association with the second object image.

### Supplementary Note 8

The meeting information management system according to supplementary note 7, wherein
in a case where the first piece of the minutes information and the second piece of the minutes information are associated with each other, the first piece of the minutes information and a third pied of the minutes information are associated with each other, and the second piece of the minutes information and the third piece of the minutes information are not associated with each other, the display processing circuit causes the first object image to be displayed on a first layer, and causes each of the second object image, and a third object image associated with the third piece of the minutes information to be displayed in parallel on a second layer below the first layer.

### Supplementary Note 9

The meeting information management system according to supplementary note 8, wherein
in a case where the first object image is displayed on the first layer, and each of the second object image and the third object image is displayed on the second layer, and in a case where an operation of moving the third object image to a layer below a layer of the second object image is received from a user, the display processing circuit causes the third object image to be displayed on a third layer below a layer of the second object image, and causes the first feature element, the second feature element, and a third feature element associated with the third piece of the minutes information to be displayed in association with the third object image.

### Supplementary Note 10

The meeting information management system according to any of supplementary notes 1 to 9, wherein
in a case where first minutes information and second piece of the minutes information are associated with each other, the display processing circuit causes a first object image associated with the first piece of the minutes information, and a second object image associated with the second piece of the minutes information to be displayed in order according to a date and time of holding the meeting, causes a first feature element associated with the first piece of the minutes information to be displayed in association with the first object image, and causes a second feature element associated with the second piece of the minutes information to be displayed in association with the second object image.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A meeting information management system, comprising:
one or more processors; and
a display device, wherein
the one or more processors
acquire minutes information of a meeting;
determine a feature element representing a feature of the minutes information, based on the minutes information, and set the determined feature element to the minutes information; and
in a case where a plurality of pieces of the minutes information to which the feature element is set are associated with each other, cause the plurality of pieces of minutes information, and the feature element associated with each of the plurality of pieces of minutes information to be displayed in an identifiable manner on the display device.

2. The meeting information management system according to claim 1, wherein
the one or more processors compute a degree of importance of each of a plurality of keywords by extracting the plurality of keywords from the minutes information, and determine, as the feature element, a keyword having a highest degree of the importance.

3. The meeting information management system according to claim 1, wherein
the one or more processors determine, as the feature element, a keyword selected by a user from among a plurality of keywords by extracting the plurality of keywords from the minutes information.

4. The meeting information management system according to claim 2, wherein
the one or more processors set the feature element in one-to-one correspondence with the minutes information.

5. The meeting information management system according to claim 2, wherein
in a case where a first piece and a second piece of the minutes information are associated with each other, the one or more processors set different feature elements to the first piece and the second piece of the minutes information.

6. The meeting information management system according to claim 1, wherein
the one or more processors determine whether a plurality of pieces of the minutes information are associated with each other, and
the one or more processors compute a degree of similarity of each of the plurality of pieces of minutes information, based on a keyword included in each of the plurality of pieces of minutes information, and determine that the plurality of pieces of minutes information are associated with each other, in a case where the degree of similarity is equal to or more than a threshold value.

7. The meeting information management system according to claim 1, wherein
in a case where a first piece and a second piece of the minutes information are associated with each other, the one or more processors cause a first object image associated with the first piece of the minutes information, and a second object image associated with the second piece of the minutes information to be displayed in order according to a date and time of holding the meeting, cause a first feature element associated with the first piece of the minutes information to be displayed in association with the first object image, and cause the first feature element, and a second feature element associated with the second piece of the minutes information to be displayed in association with the second object image.

8. The meeting information management system according to claim 7, wherein
in a case where the first piece of the minutes information and the second piece of the minutes information are associated with each other, the first piece of the minutes information and a third piece of the minutes information are associated with each other, and the second piece of the minutes information and the third piece of the minutes information are not associated with each other, the one or more processors cause the first object image to be displayed on a first layer, and cause each of the second object image, and a third object image associated with the third piece of the minutes information to be displayed in parallel on a second layer below the first layer.

9. The meeting information management system according to claim 8, wherein
in a case where the first object image is displayed on the first layer, and each of the second object image and the third object image is displayed on the second layer, and in a case where an operation of moving the third object image to a layer below a layer of the second object image is received from a user, the one or more processors cause the third object image to be displayed on a third layer below a layer of the second object image, and cause the first feature element, the second feature element, and a third feature element associated with the third piece of the minutes information to be displayed in association with the third object image.

10. The meeting information management system according to claim 1, wherein
in a case where a first piece and a second piece of the minutes information are associated with each other, the one or more processors cause a first object image associated with the first piece of the minutes information, and a second object image associated with the second piece of the minutes information to be displayed in order according to a date and time of holding the meeting, cause a first feature element associated with the first piece of the minutes information to be displayed in association with the first object image, and cause a second feature element associated with the second piece of the minutes information to be displayed in association with the second object image.

11. A meeting information management method executed by one or more processors, the method comprising;
acquiring minutes information of a meeting;
determining a feature element representing a feature of the minutes information, based on the minutes information, and setting the determined feature element to the minutes information; and
in a case where a plurality of pieces of the minutes information to which the feature element is set are associated with each other, causing the plurality of pieces of minutes information, and the feature element associated with each of the plurality of pieces of minutes information to be displayed in an identifiable manner.

12. A non-transitory computer-readable recording medium storing a meeting information management program for causing one or more processors to execute:
acquiring minutes information of a meeting;
determining a feature element representing a feature of the minutes information, based on the minutes information, and setting the determined feature element to the minutes information; and
in a case where a plurality of pieces of the minutes information to which the feature element is set are associated with each other, causing the plurality of pieces of minutes information, and the feature element associated with each of the plurality of pieces of minutes information to be displayed in an identifiable manner.
